(19) United States
(12) Patent Application Publication
(10) Pub. No.: US 2013/0208235 A1
(43) Pub. Date: Aug. 15, 2013

(54) ILLUMINATED LOW-VISION READER

(71) Applicant: VANDERBILT UNIVERSITY, (US)

(72) Inventor: Jeffrey Sonsino, Nashville, TN (US)

(73) Assignee: VANDERBILT UNIVERSITY, Nashville, TN (US)

(21) Appl. No.: 13/848,290

(22) Filed: Mar. 21, 2013

Related U.S. Application Data
(63) Continuation-in-part of application No. 13/325,293, filed on Dec. 14, 2011.
Application No. 13/325,293 is a continuation-in-part of application No. 13/090,125, filed on Apr. 19, 2011, now Pat. No. 8,109,630.
Application No. 13/090,125 is a continuation of application No. 11/532,566, filed on Sep. 18, 2006, now Pat. No. 7,942,522.
(60) Provisional application No. 60/721,544, filed on Sep. 29, 2005.

(51) Int. Cl. G02C 11/04

(52) U.S. Cl. CPC G02C 11/04
USPC 351/158

(57) ABSTRACT

A low-vision reader for individuals with low vision, includes a frame for supporting lenses, at least one oculus dexter lens supported by the frame on an oculus dexter side, and at least one oculus sinister lens supported by the frame on an oculus sinister side, and a pair of lights. Each of the lenses has an induced prism in a range between about 0 PD and about 22 PD and a lens power that is greater than about +4.00 diopters and less than +20.00 diopters such that each of the said lenses focused at a distance that is greater than about 5 cm and less than about 25 cm. Each light has a predetermined light strength is mounted adjacent the outer portions of the lenses and oriented to project light to provide a predetermined overlapping lighted area in a predetermined field.

### CROSS-REFERENCE TO RELATED APPLICATIONS

This application is a continuation-in-part of and claims benefit of U.S. patent Application Ser. No. 13/325,293, filed on Dec. 14, 2011, which status is pending and is a continuation-in-part of U.S. patent application Ser. No. 13/090,125, now as U.S. Pat. No. 8,109,630, filed on Apr. 19, 2011, which is a continuation of U.S. patent application Ser. No. 11/532,566, now as U.S. Pat. No. 7,942,522, filed on Sep. 18, 2006, which claims the benefit of U.S. Provisional Application No. 60/721,544, filed Sep. 29, 2005. The disclosures of the above applications are incorporated herein by reference in their entireties, respectively.

### FIELD OF THE INVENTION

The present invention relates to a vision enhancement system for aiding in the correction of the vision of the visually impaired.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many people in the world today suffer from some type of visual impairment. Vision impairment refers to that which cannot be adequately compensated for by using corrective lenses (glasses or contact lenses) or surgery.

Low vision is generally considered to be vision poor enough to keep someone from being able to read the newspaper while wearing their habitual glasses. Visual acuity that results in this type of impairment can range anywhere from 20/20 (with a very constricted visual field) to 20/400 or worse, depending on the cause of the vision impairment. Low vision results from a variety of diseases or conditions. Age-related macular degeneration accounts for about 65% to 75% of patients requesting vision rehabilitation. Diabetic retinopathy, glaucoma, hereditary retinal degenerations or diseases such as retinitis pigmentosa, albinism, Leber's optic neuropathy, and Best's disease account for many other causes of low vision.

In order to cope with this disability, individuals work closely with a Low Vision Rehabilitation Specialist (an optometrist or ophthalmologist who has a special interest in and who has been trained in Low Vision Rehabilitation) or other professionals who specialize in specific aspects of low vision rehabilitation, such as occupational therapists, orientation and mobility instructors, educators who specialize in teaching both children and adults with poor vision, social workers and researchers. Low Vision Rehabilitation is available in most major medical centers and, in some cases, in private practices.

A Low Vision evaluation begins with a comprehensive patient history. This includes a medical, drug, social, work, and vision history. A meticulous refraction is then done to determine the patient's best possible visual acuity. Additional tests are done to determine what is needed to enable the patient to read. This correction may range from a simple pair of reading glasses to a magnifier or a complex system such as a telemicroscope or CCTV (closed circuit TV).

Other areas of the patient's lifestyle are addressed such as work needs, hobbies, social needs, recreational needs, financial and personal needs. For example, complex systems can be designed for someone who works on a computer and who needs large print or voice-activated programs. Every effort is made to enable the individual to continue working at his/her present job, or, if necessary, retraining individuals in new areas of employment.

Low Vision Rehabilitation is an approach to making the best possible use of the healthy vision remaining in the eye. The Low Vision Specialist has at her/his disposal a vast array of devices designed to help the visually impaired see better. These can include magnifiers, microscopic lenses, telescopes, electronic devices such as closed-circuit TV's, even virtual imagery. Proper lighting used in the proper manner, bold lined writing utensils and paper, large print books and magazines, large print checks and many other useful devices help with coping with vision loss.

In addition, individuals may need to work with an occupational therapist to learn to use these devices effectively. A social worker can identify community-based programs that may be beneficial. Most people who have had expert Low Vision Rehabilitation can read, write, use their computer and generally function at a relatively high level.

However, Low Vision Rehabilitation in no way affects the physical condition of the eye. It cannot make the disease better and it cannot make it worse. The goal of Low Vision Rehabilitation is to learn to use the remaining healthy vision as effectively and efficiently as possible.

A number of devices exist in the prior art for helping individuals cope with Macular Degeneration and other visual impairments. For example, U.S. Pat. No. 5,151,722 to Massof et al, incorporated by reference herein, discloses a head-mounted display for providing a monocular or binocular wide field of view. This display contains folding optics and a CRT for projecting a viewed image onto the eye. This and similar systems known as LVES (Low Vision Enhancement Systems), have a number of significant disadvantages. These systems are large, heavy and cumbersome and cannot be worn comfortably by the patient.

Because of their weight and awkward configuration, LVES systems also have the significant disadvantage that it is difficult for the patient to read effectively while wearing the unit and it is extremely difficult to move from place to place. This is because even very small amounts of movement will create image flutter and a blurring of the image that is projected onto the patient's eyes. This undesired motion and blurring of images causes the eyes to fatigue quickly and greatly increases eye strain.

These systems also cannot be used with a patient's normal prescription glasses because of their size and configuration, and the optics contained therein. Nor can they be readily optimized for changes in a patient's condition or even for different patients. Each unit must be customized for a particular condition and for a particular patient.

U.S. Pat. Nos. 5,125,046; 5,267,331, and 5,359,675, all of which are incorporated by reference herein, also disclose an image enhancement system for the visually impaired. This system is usable as a table-mounted display system or as head-mounted video spectacles. However, this system, like the LVES system, suffers from a number of significant disadvantages. These systems are also limited in that they cannot be easily reconfigured for the changing needs of the patient, and do not allow for the patient to wear his or her own prescription glasses while wearing the head-mounted enhancement system. This is a significant disadvantage in that the rehabilitation specialist cannot easily work with the patient while wearing the device to test and help improve the patient's vision. These systems also cannot be readily optimized for the needs of a different patient, but are instead designed and built for a specific application.

Because of these significant disadvantages inherent in conventional vision enhancement systems, a visual rehabilitation system is needed which significantly reduces the susceptibility of the system to motion, is easily adaptable to the changing needs of the patient, which can be readily optimized for the needs of different patients, and which will be a tremendous aid in the rehabilitation of patients coping with low vision and other visual impairments.

Thus, it should be apparent that a need exists for improved reading glasses or spectacles for aiding patients with low-vision or macular degeneration wherein the glasses use a single lens for each eye. It is an object of the present invention to provide improved low-vision enhancement systems.

### SUMMARY OF THE INVENTION

The above and other objects are realized by the present invention, one embodiment of which relates to lighted reading glasses or spectacles for individuals with low vision, including macular degeneration, that provide enhanced viewing of text comprising:

a frame for supporting lenses having an oculus dexter side and an oculus sinister side,

at least one oculus dexter lens supported by the frame on the oculus dexter side, and at least one oculus sinister lens supported by the frame on the oculus sinister side, the lenses being adjacent to and laterally spaced from each other and providing a predetermined field of view for a user, each of said lenses having an induced prism and a lens power sufficient to enhance the reading of text in the predetermined field view of the individual with low vision; preferably having an induced prism of between 0 and 22 PD, and a lens power of between +4.00 and +20.00 diopters, and a pair of light sources each having a predetermined light strength and mounted adjacent the outer portions of the lenses and oriented to project light to provide a predetermined overlapping lighted area in the predetermined field of view.

### BRIEF DESCRIPTION OF THE DRAWINGS

FIG. 1 is a perspective view of a low vision reader or spectacles in accordance with certain embodiments of the present disclosure.

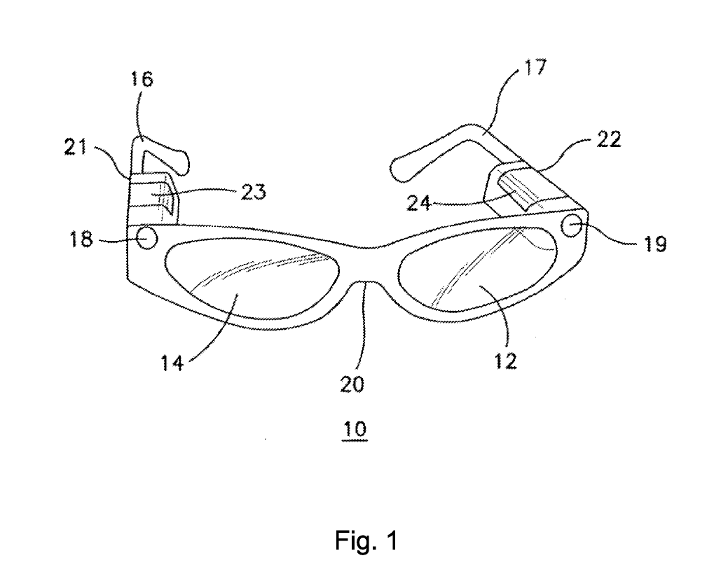

### DETAILED DESCRIPTION OF THE INVENTION

The foregoing description is merely illustrative in nature and is in no way intended to limit the disclosure, its application, or uses. It should be understood that throughout the drawings, corresponding reference numerals indicate like or corresponding parts and features. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

Terms which are not defined (including terms used for science and technology, such as technical terms or academic parlance) can be used as terms which have meaning equal to general meaning that an ordinary person skilled in the art understands. It is preferable that terms defined by dictionaries or the like be construed as consistent meaning with the background of related art.

Terms such as “first,” “second,” “third,” and the like are used for distinguishing various elements, members, regions, layers, and areas from others. Therefore, the terms such as “first”, “second”, “third”, and the like do not limit the number of the elements, members, regions, layers, areas, or the like. Further, for example, the term “first” can be replaced with the term “second”, “third”, or the like.

Terms for describing spatial arrangement, such as “over”, “above”, “under”, “below”, “laterally”, “right”, “left”, “obliquely”, “behind”, “front”, “inside”, “outside”, and “in” are often used for briefly showing a relationship between an element and another element or between a feature and another feature with reference to a diagram. Note that embodiments of the present invention are not limited to this, and such terms for describing spatial arrangement can indicate not only the direction illustrated in a diagram but also another direction. For example, when it is explicitly described that “B is over A”, it does not necessarily mean that B is placed over A, and can include the case where B is placed under A because a device in a diagram can be inverted or rotated by 180° . Accordingly, “over” can refer to the direction described by “under” in addition to the direction described by “over”. Note that embodiments of the present invention are not limited to this, and “over” can refer to any of the other directions described by “laterally”, “right”, “left”, “obliquely”, “behind”, “front”, “inside”, “outside”, and “in” in addition to the directions described by “over” and “under” because the device in the diagram can be rotated in a variety of directions. That is, the terms for describing spatial arrangement can be construed adequately depending on the situation.

Terms such as “about,” “approximately,” “generally,” “substantially” unless otherwise indicated mean within 20 percent, preferably within 10 percent, further preferably within 5 percent, and even more preferably within 3 percent of a given value or range. Numerical quantities given herein are approximate, meaning that the term “about,” “approximately,” “generally,” or “substantially” can be inferred if not expressly stated.

The term dioptre, or diopter, is a unit of measurement of the optical power of a lens or curved mirror, which is equal to the reciprocal of the focal length measured in meters (that is, 1/meters). It is thus a unit of reciprocal length. For example, a 3-diopter lens brings parallel rays of light to focus at ⅓ meter.

The term prism diopter (PD) is a measure of prism correction. Eye care professionals use prism correction as a component of some eyeglass prescription. A lens with prism correction displaces the image, which is used to treat muscular imbalance or other conditions that cause errors in eye orientation. Prism correction is measured in prism diopters. The prism diopter of a lens is equal to one hundred times the tangent of the angle by which it displaces an image seen through the lens. Prism diopter is represented by the Greek symbol delta (A). A prism of power 1Δ would produce 1 unit of displacement for an object held 100 units from the prism. Thus a prism of 1Δ would produce 1 cm visible displacement at 100 cm. 2Δ would produce 2 cm displacement at 100 cm, and so on.

P=100 tan d

Where P is the amount of prism correction in prism diopters, and d is the angle of deviation of the light.

It is discovered that low vision in patients suffering therefrom can be vastly improved by employing lighted reading glasses wherein the lenses contain induced prism and the glasses are equipped with devices that project light onto the field of vision. The lenses of the spectacles preferably have a dioptic power of from about +4.00 to about +20.00 and a prism preferably of from about 0 PD to about 22 PD (for example, between 0 and 22 PD, or between 4 and 22 PD). The eyeglasses are able to project sufficient light on the area of focus to aid in the reading of written or typed information therein.

The low-vision reader (LVR) or spectacles of the present disclosure can be far less bulky, transportable and easier to use than the reading aids heretofore employed for those with low vision.

The present disclosure is further illustrated by reference to the drawing which depicts the LVR or spectacles 10 according to the present disclosure, in which are located, mounted in frame 20, lenses 12 and 14, each having a predetermined dioptic power and prism. The LVR are further provided with temple arms 16 and 17 for affixing the spectacles over the ears of the user. The temple arms, 16 and 17 are preferably connected by a hinge to the frame 20 to allow folding of the glasses into a compact shape and size suitable for ease of carrying and transporting. Mounted on the LVR, preferably on the front of the frame 20 are light sources 18 and 19, preferably LEDs that project light onto an area of focus 22. It will be understood by those skilled in the art that any type of light sources capable of projecting light onto the area of focus sufficient to aid the user in reading may be employed in place of the depicted LEDs. A light source is preferably placed at each temple, i.e., the front of the frame 20 adjacent to the temple arms so as to focus at substantially the same distance that the lenses focus. The light sources are also preferably provided with power sources (not shown) such as batteries, preferably located in housings 21 and 22, which are preferably mounted on the interior sides of temple arms 16 and 17, adjacent to the area at the rear of frame 20 which, in turn, is adjacent to light projectors 18 and 19. Each power source is preferably actuated by a switch means 23 and 24, which may be incorporated into housings 21 and 22 so as to either automatically effectuate supply of electrical power to the light sources 18 and 19 when the glasses 10 are unfolded from their compact state for use by the intended user or so as to be manually operable by the intended user when desired or both. It will be understood that the present disclosure also embodies the use of one or more than two light sources in such applications where such arrangements are advantageous. The LVR is preferably designed to focus at a maximum distance of 25 cm and a minimum of 5 cm (i.e., between +4.00 and +20.00 diopters).

The predetermined lighted areas of focus are designed to preferably comprise cones of light increasing in size further from the LVR so that the overlapping lighted area has a conical shape leaving only peripheral areas in the field of view of the lenses that are lit by a single one of the lights with the peripheral areas becoming progressively smaller as distances from the lenses increase.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A low-vision reader for a user with low vision, comprising:
a frame for supporting lenses having are oculus dexter side and an oculus sinister side;
at least one oculus dexter lens supported by the frame on the oculus dexter Side, and at least one oculus sinister lens supported by the frame on the oculus sinister side, each of said lenses being adjacent to and laterally spaced from each other and providing a predetermined field for the user, and each of said lenses having an induced prism in a range between about 0 PD and about 4 PD and a lens power that is greater than about +4.00 diopters and less than about +20.00 diopters such that each of said lenses focuses at a distance that is greater than about 5 cm and less than about 25 cm; and
at least one light source having a predetermined light strength oriented to project light to provide a predetermined lighted area in said predetermined field.

2. The low-vision reader of claim 1, wherein the at least one light source comprises two light sources, each light source mounted adjacent the outer portions of the lenses oriented to project light to provide a predetermined lighted area overlapping said predetermined field.

3. The low-vision reader of claim 2, wherein the predetermined lighted areas are cones of light increasing in size further from the glasses so that the overlapping lighted area has a conical shape leaving only peripheral areas in the field of the lenses that are lit by a single light source with the peripheral areas becoming progressively smaller as distances from the lenses increase.

4. The low-vision reader of claim 1 wherein the at least one light source is a high intensity light-emitting diode.

5. The low-vision reader of claim 1 additionally comprising a power source for supplying electrical power for said at least one light source.

6. The low-vision reader of claim 5, wherein said power source is a battery.

7. The low-vision reader of claim 1 including elongate temple arms having forward and rearward ends with the arms extending rearwardly from adjacent the outer portions of the lenses.

8. The low-vision reader of claim 1 additionally comprising switch means for either automatically or manually effectuating a supply of electrical power to the at least one light source.

9. An oculus lens usable in a low-vision reader for a user with low vision, comprising:
an induced prism in a range between about 0 PD and about 4 PD with a lens power that is greater than about +4.00 diopters and less than about +20.00 diopters such that in use, the oculus lens focuses at a distance that is greater than about 5 cm and less than about 25 cm.

10. The oculus lens of claim 9, being an oculus dexter lens.

11. The oculus lens of claim 9, being oculus sinister lens.

12. A pair of oculus lenses usable in a low-vision reader for a user with low vision, comprising:
at least one oculus dexter lens; and
at least one oculus sinister lens,
wherein each of said lenses has an induced prism in a range between about 0 PD and about 4 PD and a lens power that is greater than about +4.00 diopters and less than about +20.00 diopters such that in use, each of said lenses focuses at a distance that is greater than about 5 cm and less than about 25 cm.
